(19) United States
(12) Patent Application Publication
(10) Pub. No.: US 2003/0167275 A1
(43) Pub. Date: Sep. 4, 2003

(54) Computation of frequent data values

(76) Inventor: Walid Rjaibi, Kilchberg (CH)

Correspondence Address: SAWYER LAW GROUP, P.O. Box 51418, Palo Alto, CA, 94303, US

(21) Appl. No.: 10/374,548

(22) Filed: Feb. 25, 2003

(30) Foreign Application Priority Data
Mar. 1, 2002 (CA) 2,374,298

(51) Int. Cl. G06F 7/00; G06F 17/00

(52) U.S. Cl. 707/101

(57) ABSTRACT

Computing frequent value statistics, such as the top most frequent values in a data column, in a database management system. In one aspect, a list is generated of at least N data values obtained from a data set that comprises data values and associated counts, where the counts are representative of the frequency of occurrence of each data value. For a selected data value, the associated count is compared with a threshold and if the count is greater than the threshold, and the list has N data values, the least frequently occurring data value and associated count in the list are replaced with the selected data value and associated count, and the threshold is modified.

### FIELD OF THE INVENTION

This invention relates generally to determining frequent data values within a set of data values and more particularly to determining a set of frequent data values that occur within a set of data values.

### BACKGROUND OF THE INVENTION

To ensure generation of an efficient query response plan, a database management system typically includes a query optimization software module. The query optimization software module generates search plans for query requests based on optimization rules that consider, among many variables, the size of the response set (amount of data expected to be returned) and the frequency of occurrences (frequent values) of unique values within the data being queried.

Frequent value statistics (frequency of occurrences of unique values within a set of values) are among the most commonly required statistics used by the query optimization software module. Frequent value statistics are used in conjunction with other statistics to compute query plan resource consumption estimates which are then used in determining the most efficient plan for a given query.

Current, accurate statistics in database management systems are highly desired by query optimizers of such systems. When statistics are inaccurate or not current, a query optimizer is more likely to generate less efficient query plans. Low efficiency query plans perform poorly at run time, degrading overall database system performance.

For a fixed number N, where N is greater than one, the N most frequent values in a set of data values consists of the data value having the highest frequency (here frequency means the number of occurrences of a specific data value), the data value having the second highest frequency, and so forth, down to the data value having the Nth highest frequency. The corresponding frequent value statistics consist of these “N” number of data values together with their respective frequencies. For example, a frequent value statistic may include the following ranked data value pairs (each pair comprising a distinct data value and an associated frequency value): (4, 5), (3, 4), (7, 2), which means data value “4” occurred 5 times, data value “3” occurred 4 times and data value “7” occurred 2 times in the set of data values. Data values are not restricted to numbers only. The data value may be a character string such as a name. The listing of most frequent values for a set of names may then be a simple list of those names according to the frequency of occurrence for each name.

To compute the N most frequent values in a set of data, where that set is in a column within a database, a database manager application typically performs at least two sort operations. The first sort is on the data values in the column gathering like entries together. The second sort is on the data values according to their frequencies. The column value frequencies are easily computed, using known techniques, after the first sort has been performed. The N most frequent values may be computed for every column in a database table with the computation resulting in a significant processing burden for large database systems. The significant processing overhead related to frequent value statistics has resulted in a number of techniques being employed to produce approximations of frequent value statistics.

The approximation techniques are generally divided into two categories of sampling and hashing based techniques. The sampling based technique employs the same two sorts as typically done before, but this time only on a sample of the total data values. In this technique, processing overhead can be reduced compared to the overhead related to processing a full set of data by reducing the data sample size. Processing overhead is reduced but at the expense of accuracy due to the smaller sample size being employed.

The hashing technique employs more than one hashing function to scan and process the data values into multiple hashing locations typically stored in an array or vector. When a value in a hashed location reaches a predetermined fixed threshold value, the corresponding column data value is declared a candidate frequent value. According to the hashing technique, a single sort is then performed to determine the N most frequent values from among the candidate frequent values. A limitation of the hashing technique is difficulty in predetermining an appropriate threshold value.

To summarize, current techniques have been employed to reduce the computational impact of generating frequent value statistics on the database system. The example techniques of sampling and hashing described provide approximations of frequent value statistics as a result of processing overhead tradeoff. From the examples described it should be apparent that there is a need for enhancing database management systems statistical computations so that statistics such as frequent value statistics used in query optimizations may be obtained with improved accuracy, or improved efficiency or both.

### SUMMARY OF THE INVENTION

The present invention provides a technique for frequent value computations in database management systems.

In a first aspect of the invention there is provided a method for generating a list of at least N data values obtained from a data set, the data set comprising unique data values and associated counts, and the counts representative of the frequency of occurrence of each unique data value in the data set. For a selected data value, the count associated with the selected data value is compared with a threshold and if the count is greater than the threshold, and the list comprises N data values, the least frequently occurring data value and associated count in the list are replaced with the selected data value and associated count, and the threshold is modified. If the list comprises less than N data values, the selected data value and associated count can be inserted into the list.

In a second aspect of the invention there is provided a method for generating a list of frequent data values obtained from a data set, the data set comprising data values and associated counts, and the counts representative of the frequency of occurrence of each data value in the data set. The count associated with a selected data value is compared with a threshold and if the count is greater than the threshold and the list is full, the most frequently occurring data value and associated count in the list are replaced with the selected data value and associated count, and the threshold is modified. The selected data value and associated count can be inserted into the list if it is not full.

In a third aspect of the invention there is provided a computer system having means for selecting a data value and comparing the count associated with the selected data value with a threshold. The computer system further provides means for inserting the selected data value and associated count into a list, if the count is greater than the threshold and the list is not full. Further means are provided for replacing the least frequently occurring data value and associated count in the list with the selected data value and associated count if the count is greater than the threshold and the list is full, and additional means for modifying the threshold.

In a fourth aspect of the invention there is provided a computer-readable medium including program instructions for determining a list of frequent value statistics in a database management system, where the program instructions select a data value, and compare the count associated with the selected data value with a threshold. The selected data value and associated count are inserted into the list, if the count value is greater than the threshold and the list is not full. The least frequently occurring data value and associated count in the list are replaced with the selected data value and associated count if the count is greater than the threshold and the list is full, and the threshold is modified.

The invention uses a varying and dynamically maintained threshold value to compute, rather than estimate, the N most frequent values in a set of data values without the need to do sorting. The invention is suitable for use in database management systems where performance and reliable statistics are valued. Other features and advantages of the present invention should be apparent from the following description of the preferred embodiment, which illustrates, by way of example, the principles of the invention.

### BRIEF DESCRIPTION OF THE DRAWINGS

An embodiment of the present invention will be described by way of example with reference to the accompanying drawings, in which:

FIG. 1 is a block diagram showing a data processing system embodying aspects of the current invention within a database management system;

FIG. 2 is a flow diagram showing the frequent value statistics process flow employed by the embodiment of FIG. 1;

FIG. 3 is a block diagram showing an example of an ordered list of frequent values which may be obtained on output of the process shown in FIG. 2;

FIG. 4 is a block diagram showing an example of a member of an ordered list of frequent values of FIG. 3;

FIG. 5 is a block diagram showing an example of pairs of data values and count values in a storage location (e.g., an array of counts referred to in operations 220 and 230 of FIG. 2).

### DETAILED DESCRIPTION

In database query processing the knowledge of frequent value statistics is important for the generation of efficient query plans. The efficiency of query operations directly affects the performance of the relational database management system.

The present invention provides a solution allowing a database management application to more efficiently compute the frequent values contained within a column. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

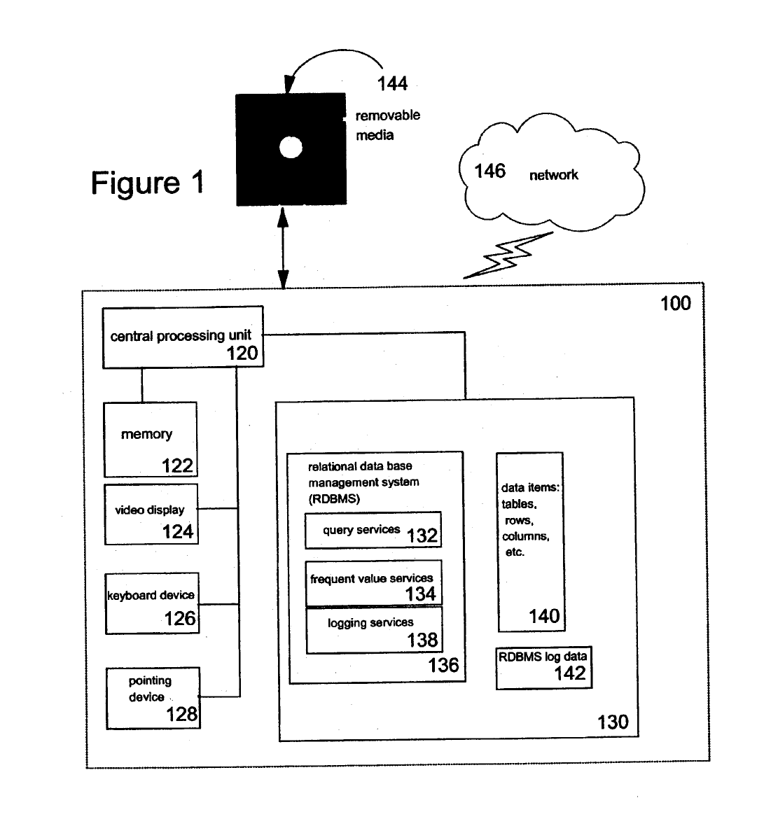

Referring to FIG. 1, a data processing system 100 is shown incorporating a database management system containing an embodiment of the present invention. The example shown using a database management system is illustrative of an embodiment of the invention only and not limiting the applicability, as the concept may be used elsewhere such as with flat files and hierarchical databases and in differently configured processing systems. The data processing system 100 comprises a central processing unit 120, a memory 122, a video display 124, a keyboard 126, a pointing device 128, a storage device 130, (which may be disk or tape or other suitable device for data storage), removable media 142 and a network 144. One of ordinary skill in the art will recognize the data processing system 100 as a general purpose digital computer.

Referring again to FIG. 1, the relational database management system 136 as shown, comprises a software module which is stored on and loaded from a storage device 130. While only one system is depicted, it is well known that the data and database management system may be maintained in other embodiments such as combining or connecting different systems by a network 146. The relational database management system 136 comprises functional modules such as query services 132, frequent values services 134 and logging services 138. Data items 140 may be rows, columns, tables, associated with and used by, the relational database management system 136. Data items 140 and RDBMS log data 142 typically include textual data comprised of character strings that may or may not be numeric, but could also be other uniquely identifiable objects and may be stored on the same storage device 130 or other storage means such as 144. The primary function of the frequent values service 134 is to generate accurate frequent value statistics associated with specified data values (data items 140 and RDBMS log data 142) in a database. The frequent value statistics are then used for query optimization by the query services 132 to build and run query plans. The logging facilities 138 captures information related to specific database events, records such information as RDBMS log data 142 for subsequent uses such as transaction recovery, reporting or other processing.

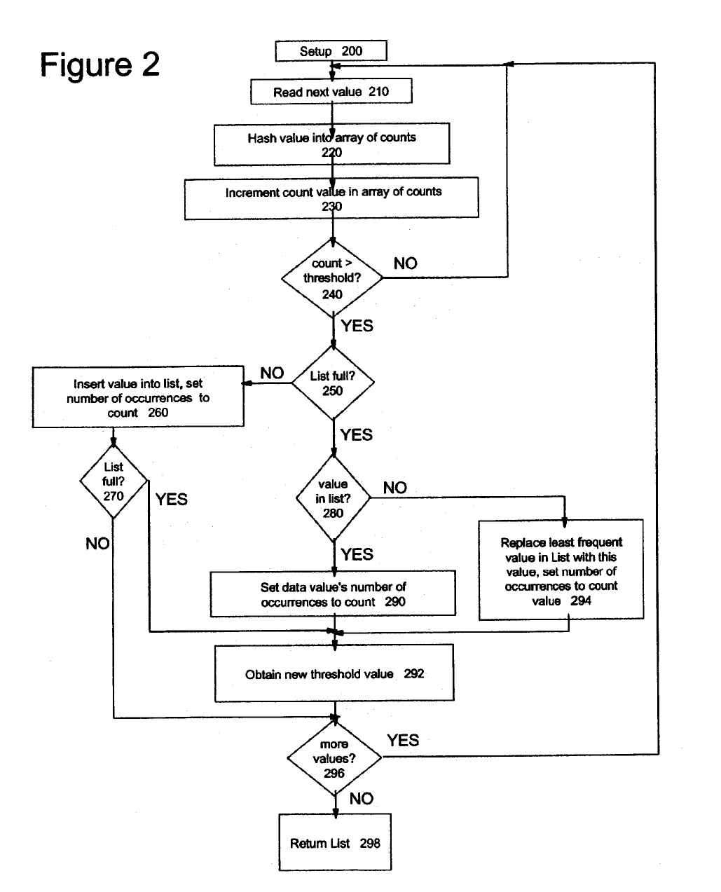

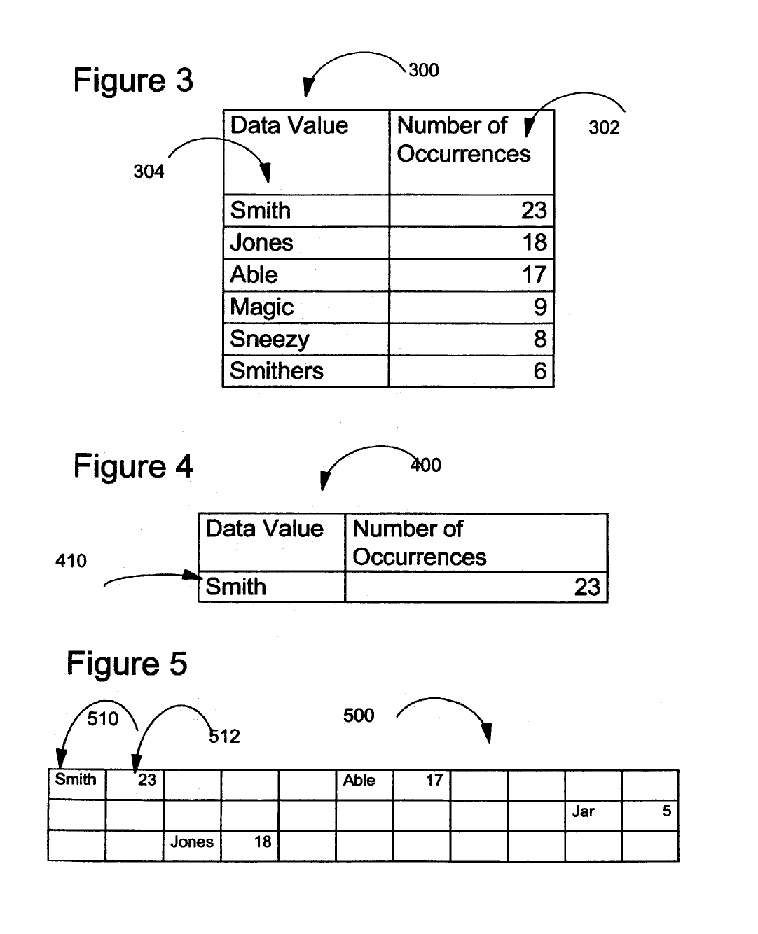

FIG. 2 is a flowchart illustrating an exemplary method of calculating the most frequent values for a column of data values as may be found in a system as described in FIG. 1. The exemplary frequent value services 134 begins with a setup operation 200, where memory is allocated for an array of counts (a simple array of elements, where each element represents a data pair comprising a data value and an associated count value, an example of which is shown as array 500 in FIG. 5) and a list of most frequent values (an example of which is shown as table 300 in FIG. 3) and other usual initialization activity occurs. The size of the array is determined by the number of unique data values in the input set and the size of the list is determined by the number of most frequent values desired for output. The number of most frequent values (the number of entries to be contained in the list of most frequent values) desired is typically provided as an input constraint to the process by the user requesting the frequent value computation. If not provided by a requesting user, the number desired may be determined by configuration defaults or other programmatic criteria. Each member in the most frequent values list is composed of a data value and a value representing the number of occurrences of the associated data value ( i.e., a count value), an example of which is shown as entry 410 in table 400 of FIG. 4. A frequent value threshold is initialized to a default value, (used later for determining candidate frequent values). The value 2 is typically chosen to establish a test value that is greater than the count value for a single occurrence of a unique data value. Other default values may be chosen. When operation 200 completes, operation 210 is performed.

A data value from a set of data values (i.e., a data value from data items 140 or RDBMS log data 142 as shown in FIG. 1) is obtained during operation 210 from a memory location for processing in operation 220. During operation 220 a hashing function is applied to the data value obtained in operation 210. The hashing function generates a value identifying a precise position in the array of counts for placement of the data value. For example, hashing the data value SMITH to location 510 in the array as shown in FIG. 5. Once placed, operation 230 increments the count value associated with that position by one to indicate one occurrence and moves to operation 240. In FIG. 5, the count value associated with SMITH is shown at 512, containing the count value 23. Although the example shown in FIG. 5 depicts a physical relationship between the data value and the count value, a logical relationship would provide equivalent function.

During operation 240, the count value, incremented in operation 230, is compared to the frequent value threshold. If the count just incremented in operation 230 is less than the threshold, processing returns to perform operation 210 otherwise processing proceeds to perform operation 250. During operation 250, the frequent value services 134 ( FIG. 1) checks whether the list of most frequent values 300 (FIG. 3) is now full. If the list 300 is not full, the frequent value services 134 proceeds to operation 260 otherwise to operation 280.

During operation 260, the data value obtained during operation 210 is inserted into the list of most frequent values 300 and its associated number of occurrences is set to the count value obtained from the array position resulting from the previous hashing operation performed during operation 220. The process then moves to operation 270 where a determination is made regarding the full condition of the list of most frequent values 300 (does list 300 contain as many members as requested?). If the list of most frequent values 300 is not full, processing moves to operation 296 where a check is made to determine whether there are additional data values in the column. If additional data values exist, processing is directed to perform operation 210. If the column being analyzed has no more data values to read, then the process completes at operation 298.

If during operation 270 it was determined that the list 300 was full, processing would then be directed to operation 292 where a new threshold value would be determined. The new threshold value would be set to the smallest number of occurrences currently found in the list of most frequent values 300 for the column and processing would then proceed to operation 296.

If during operation 250, it was determined that the list 300 was full, processing would then be directed to operation 280. During operation 280 the process determines if the data value has already been stored in the list of most frequent values for the column. If the data value was already in the list 300, processing moves to operation 290 where the number of occurrences field 302 corresponding to this data value 304 in the list of most frequent values 300 is set to the count value corresponding to the array position indicated as a result of the previous hashing performed during operation 220. Processing then moves to operation 292 to obtain a new threshold value.

If during operation 280 it was determined that the data value was not in the list of most frequent values 300, processing would then be directed to operation 294 where the list of most frequent values would be checked to find the value having the smallest number of occurrences. The value found is replaced by the current data value and its associated number of occurrences is set to the count from the array position to which this data value hashed in operation 220. Processing would then be directed to operation 292 to obtain a new threshold value.

Alternatives of the illustrated embodiment may include modifications such as changing the count threshold value settings and action (see operation 240 of FIG. 2) to determine the least most frequent values or creating the array of data value and count value pairs (combining operations 210, 220, and 230) before performing the operation 240 of FIG. 2.

In summary of an aspect of the present invention, a method is provided for computing frequent value statistics, such as the top most frequent values in a data column, in a database management system using a combination of hashing techniques and a varying and dynamic threshold value to compute the N most frequent values within a data column. A varying threshold value allows the method to ignore any data value that is not at least more frequent than the least frequent data value already in the list. During the column scan, a data value can enter and exit the list of most frequent values depending upon the data value's own frequency relative to that of another data value. On completion of the column scan, the list created already holds the N most frequent values obviating the need for a further sort operation. The method is suited for use in database management systems where performance and reliable statistics are valued.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for generating a list of at least N frequent data values obtained from a data set comprising a plurality of data values and associated counts representative of frequencies of occurrence of said data values, the method comprising:
(a) comparing the associated count of a selected data value with a threshold; and
(b) if said count is greater than said threshold and said list comprises N data values, replacing the least frequently occurring data value and associated count in said list with said selected data value and associated count, and modifying said threshold.

2. The method of claim 1 wherein if said count is greater than said threshold and said list comprises less than N data values, further comprising the step of inserting said selected data value and associated count into said list.

3. The method of claim 2, wherein modifying said threshold includes copying said count associated with said least frequently occurring data value in said list to said threshold.

4. The method of claim 2, wherein said replacing the least frequently occurring data value and associated count with the selected data value and associated count is performed if the selected data value is not already in said list.

5. The method of claim 3 wherein said selected data value is selected from at least one of: a database system, and a flat file.

6. The method of claim 1, wherein said method is contained in a database management system.

7. The method of claim 1 wherein said list is used by a query optimization component of a database management system.

8. A method for generating a list of frequent data values obtained from a data set, said data set comprising data values and associated counts, said counts representative of the frequency of occurrence of each said data value in said data set, the method comprising:
(a) comparing said count associated with a selected data value with a threshold; and
(b) if said count is greater than said threshold and said list is full, replacing the most frequently occurring data value and associated count in said list with said selected data value and associated count, and obtaining a new threshold to replace said threshold.

9. The method of claim 8 wherein if said count is less than said threshold and said list is not full, further comprising the step of inserting said selected data value and associated count into said list.

10. The method of claim 9, wherein obtaining a new threshold includes copying said count associated with said most frequent value in said list as said new threshold.

11. A method for determining the frequency of data values in a set of data values comprising:
(a) obtaining a data value from among data values in a set of data values;
(b) mapping the obtained data value to a position in an array of counts and incrementing a count value associated with the position;
(c) obtaining the next data value if the count value associated with the obtained data value is less than or equal to a threshold value; and
(d) if the associated count value is greater than the threshold value:
(i) if a list of most frequent values is not full, writing the obtained data value and associated count value to the list, and if the list is now full, obtaining a new threshold value;
(ii) if the list of most frequent values is full:
(A) copying the associated count value of the selected data value to the count value associated with a matching data value found in the list, and if the selected data value is not already in the list, replacing the least frequent data value and associated count value in the list with the selected data value and associated count value; and
(B) obtaining a new threshold value;
(iii) obtaining the next data value and returning to step (b).

12. The method of claim 10 wherein all the data values in the set of data values are obtained and processed in the method.

13. The method of claim 10, wherein obtaining a new threshold value includes copying said count associated with said least frequent data value in said list to said threshold value.

14. A computer system comprising:
means for selecting a data value and comparing a count associated with said selected unique data value with a threshold;
means for inserting said selected data value and associated count into a list if said count is greater than said threshold and said list is not full;
means for replacing the least frequently occurring data value and associated count in said list with said selected data value and associated count if said count is greater than said threshold, and said list is full; and
means for modifying said threshold.

15. The computer system of claim 14, wherein the means for modifying said threshold further comprises:
means for copying said count associated with said least frequent value in said list to said threshold when said list is full and the least frequent value in said list was updated by said selected data value.

16. The computer system of claim 14 wherein said computer system is configured to operate in conjunction with other computer systems in a network environment.

17. The computer system of claim 16 wherein the network environment is at least one selected from: an Intranet, an Extranet and the Internet.

18. A computer readable medium including program instructions for determining a list of frequent data values in a database management system, the program instructions for implementing steps comprising:
selecting a data value and comparing a count associated with said selected data value with a threshold;
inserting said selected data value and associated count into said list if said count is greater than said threshold and said list is not full;
replacing the least frequently occurring data value and associated count in said list with said selected data value and associated count, and modifying said threshold, if said count is greater than said threshold and said list is full.

19. The computer readable medium of claim 18, wherein the medium is a recordable data storage medium.

20. The computer readable medium of claim 18, wherein the medium is selected from a group consisting of magnetic, optical, biological and atomic storage media.

21. The computer readable medium of claim 20, wherein the medium is a modulated carrier signal.

22. The computer readable medium of claim 21, wherein the modulated carrier signal is a transmission over a network selected from a group consisting of the Internet, Intranet and Extranet.
